(19) United States
(12) Patent Application Publication
(10) Pub. No.: US 2021/0017469 A1
(43) Pub. Date: Jan. 21, 2021

(54) MICROWAVE EXTRACTION SYSTEM

(71) Applicant: Chen Hsieh, Kaohsiung City (TW)

(72) Inventor: Chen Hsieh, Kaohsiung City (TW)

(21) Appl. No.: 16/514,979

(22) Filed: Jul. 17, 2019

(51) Int. Cl. C11B 9/02; B01D 11/02; G01N 1/44

(52) U.S. Cl. CPC C11B 9/025; G01N 2001/4061; G01N 1/44; B01D 11/02

(57) ABSTRACT

A microwave extraction system comprises a sealed microwave box, a stirrer, a vacuum extraction tank, a vacuum machine, and an ice-water circulation unit; wherein the sealed microwave box is a tank-body set with microwave generators for accommodating the vacuum extraction tank and the stirrer, and the microwave generated by the microwave generators can penetrate into the tank-body; wherein the tank-body is set with a sealing cap to form a sealed space, and the stirrer can stir the object to be extracted; wherein the vacuum extraction tank is for placing the object to be extracted and providing the microwave penetration; wherein the ice-water circulation unit provides ice water to the tank-body; after completing the extraction operation, the ice-water circulation unit is turned-off and microwave-control to an appropriate temperature by the microwave generators; then turning-on the vacuum to perform concentration under reduced pressure; thereby improving microwave efficiency and reducing maintenance cost.

### TECHNICAL FIELD OF THE INVENTION

The present invention is a microwave extraction system, especially a microwave extraction system that can improve microwave efficiency and reduce repair and maintenance costs of damage.

### DESCRIPTION OF THE PRIOR ART

Due to the advancement of biotechnology and the awareness of national health care, the effective ingredients and active substances in organic substances are taken as medicines and foods for eating to replace the chemically synthesized medicines and foods; thereby reducing the chemical synthetic substances remained in the body or the side effects.

Therefore, how to efficiently extract organic matter from cells without destroying the effective ingredients and active substances, and at the same time, the extraction speed can be improved and the extraction cost can be reduced; which are the objects which the current industry are eager to solve.

At present, the extraction methods of organic substances mainly include high-temperature water extraction method, organic solvent extraction method, microwave extraction method and supercritical fluid extraction method.

In the case of supercritical fluid extraction, since it uses a supercritical fluid (such as carbon dioxide) as a medium for extraction, its operating temperature is comparatively lower; it is not easy to destroy the active substances and effective ingredients which will be extracted in the cells; however, the supercritical fluid extraction method has the disadvantages of high equipment cost and slow extraction operation speed, which make the overall extraction efficiency poorer, and has the disadvantage of increasing the extraction operation cost.

In the case of microwave extraction method, the high-frequency electromagnetic wave is used to penetrate the internal cells of the extracted materials; so that the polar water molecules generate high-speed rotation and high-frequency vibration, causing friction between the water molecules to increase the internal temperature and even evaporate. When the internal pressure of the cell exceeds the ability of the cell wall to expand, the cell wall is broken, so that the components to be extracted are discharged, and then filtered to obtain the desired extracted materials.

For example, the invention patent of the Republic of China Announcement No. 1543806 is provided with a microwave warming device and a freezing desuperheater; which utilizes a plurality of curved loops of pipelines with turns and bends to convey the to-be-extracted material; so that the to-be-extracted material can alternately heat up and cool down to destroy the cells of the to-be-extracted material to be ruptured to form the extracted materials.

Although the above-mentioned extraction system can surely rupture the to-be-extracted material to form the extracted materials; because the system is provided with a plurality of curved loops of pipelines with turns and bends, it is easy to cause the to-be-extracted material to be blocked and deposited in the pipeline; therefore resulting in poor microwave extraction efficiency and it is easy to damage the pipeline; which will increase the repair and maintenance costs.

### SUMMARY OF THE INVENTION

The purpose of the present invention is to improve the above-mentioned defects, and to provide a microwave extraction system capable of improving microwave efficiency, reducing repair and maintenance costs of damage, and performing concentration under reduced pressure.

In order to achieve the above-mentioned objects, the microwave extraction system of the present invention comprises a sealed microwave box, a stirrer, a vacuum extraction tank, a vacuum machine, and an ice-water circulation unit; wherein:

The sealed microwave box is a tank-body for accommodating the vacuum extraction tank and the stirrer; wherein at least two sets of notches are recessedly set on the side walls of the tank-body, and the side walls of the notches are set with waterproof wave-transmittable plates; wherein the two sets of notches are set with microwave generators, which the microwave generated by the microwave generators can penetrate into the tank-body through the waterproof wave-transmittable plates; further, the notches are set with protective plates facing the outer sides of the microwave generators, and the protective plates can prevent and block the microwave generated by the microwave generators from leaking out; furthermore, the tank-body is set with a sealing cap which is pivotally set with sealing drivers; wherein the sealing cap can be tightly covered on the tank-body and a sealed space is formed in the tank-body by the driving and controlling of the sealing drivers; and, the microwave generators are pivotally connected with a microwave protective device; wherein the microwave protective device is connected with a sensing piece, and the sensing piece extends into the vacuum extraction tank for sensing the temperature in the vacuum extraction tank; thereby adjusting and controlling the microwave intensity of the microwave generators.

The stirrer is set on the bottom side of the sealed microwave box and comprises a rotary motor pivotally connected with a magnetic plate, wherein the magnetic plate can be rotated by the driving of the rotary motor.

The vacuum extraction tank is set in the sealed microwave box for providing the object to be extracted to be placed in, and the vacuum extraction tank can also provide the microwave to penetrate; wherein a stirring plate is set in the vacuum extraction tank, and the stirring plate corresponds to the magnetic plate of the stirrer; when the magnetic plate rotates, the stirring plate can rotate synchronously to stir the object to be extracted; wherein the vacuum extraction tank is set with an extraction sealing cap for closing and sealing the vacuum extraction tank, which a vacuum machine and a vacuum pump are set on the sealing cap; therefore a vacuum state can be formed in the vacuum extraction tank to perform the function of concentration under reduced pressure.

The ice-water circulation unit comprises an ice-water cycle machine pivotally connected with a pipeline; wherein the pipeline is pivotally connected with a freezer controller for making the water liquid transported from the ice-water cycle machine to form ice water in the pipeline; wherein the other end of the pipeline is connected with the tank body of the sealed microwave box, so that the ice water can be transported into the tank-body. In addition, the pipeline is pivotally connected with a sensing piece extending into the tank-body for sensing the temperature in the tank-body to adjust and control the temperature of the water liquid transported into the tank-body.

Thereby, the present invention provides a microwave extraction system capable of improving microwave efficiency, reducing repair and maintenance costs of damage, and performing concentration under reduced pressure.

### BRIEF DESCRIPTION OF THE DRAWINGS

FIG. 1 is a system schematic diagram of the present invention.

FIG. 2 is a system and action schematic diagram of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

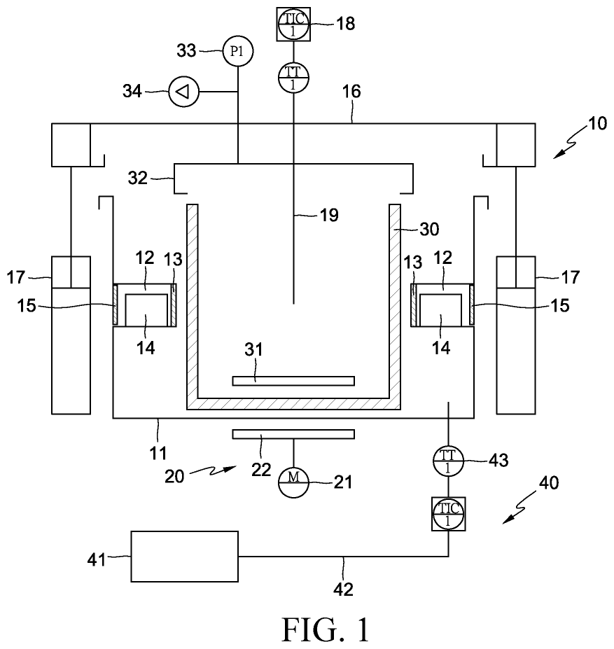

As shown in FIG. 1, the microwave extraction system in the embodiment comprises a sealed microwave box 10, a stirrer 20, a vacuum extraction tank 30 and an ice-water circulation unit 40; wherein:

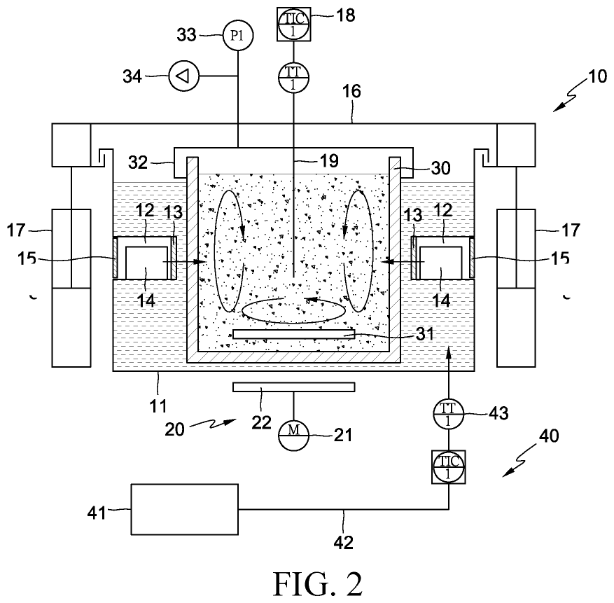

The sealed microwave box 10 (please refer to FIG. 2 at the same time) is a tank-body 11 for accommodating the vacuum extraction tank 30 and the stirrer 20; wherein at least two sets of notches 12 are recessedly set on the side walls of the tank-body 11, and the side walls of the notches 12 are set with waterproof wave-transmittable plates 13; wherein the two sets of notches 12 are set with microwave generators 14, which the microwave generated by the microwave generators 14 can penetrate into the tank-body 11 through the waterproof wave-transmittable plates 13; further, the notches 12 are set with protective plates 15 facing the outer sides of the microwave generators 14, and the protective plates 15 can prevent and block the microwave generated by the microwave generators 14 from leaking out; furthermore, the tank-body 11 is set with a sealing cap 16 which is pivotally set with sealing drivers 17; the sealing cap 16 can be tightly covered on the tank-body 11 and a sealed space is formed in the tank-body 11 by the driving and controlling of the sealing drivers 17; and, the microwave generators 14 are pivotally connected with a microwave protective device 18; wherein the microwave protective device 18 is connected with a sensing piece 19, and the sensing piece 19 extends into the vacuum extraction tank 30 for sensing the temperature in the vacuum extraction tank 30; thereby adjusting and controlling the microwave intensity of the microwave generators 14.

The stirrer 20 (please refer to FIG. 2 at the same time) is set on the bottom side of the sealed microwave box 10, which comprises a rotary motor 21 pivotally connected with a magnetic plate 22, wherein the magnetic plate 22 can be rotated by the driving of the rotary motor 21.

The vacuum extraction tank 30 (please refer to FIG. 2 at the same time) is set in the sealed microwave box 10 for providing the object to be extracted to be placed in, and the vacuum extraction tank 30 can also provide the microwave to penetrate; wherein a stirring plate 31 is set in the vacuum extraction tank 30, and the stirring plate 31 corresponds to the magnetic plate 22 of the stirrer 20; when the magnetic plate 22 rotates, the stirring plate 31 can rotate synchronously to stir the object to be extracted; wherein the vacuum extraction tank 30 is set with an extraction sealing cap 32 for closing and sealing the vacuum extraction tank 30, which a vacuum machine 33 and a vacuum pump 34 are set on the sealing cap 32; therefore a vacuum state can be formed in the vacuum extraction tank 30 to perform the function of concentration under reduced pressure.

The ice-water circulation unit 40 (please refer to FIG. 2 at the same time) comprises an ice-water cycle machine 41 pivotally connected with a pipeline 42; wherein the pipeline 42 is pivotally connected with a freezer controller 43 for making the water transported from the ice-water cycle machine 41 to form ice water in the pipeline 42; the sealed microwave box 10, so that the ice water can be transported into the tank-body 11. In addition, the pipeline 42 is pivotally connected with a sensing piece 43 used for sensing the temperature in the tank-body 11 to adjust and control the temperature of the water liquid transported into the tank-body 11.

With the above configuration, the object to be extracted can be placed in the vacuum extraction tank 30, then the vacuum extraction tank 30 can be placed in the tank-body 11 of the sealed microwave box 10; and then the sealing drivers 17 can be controlled and drived to make the sealing cover 16 close and seal the tank-body 11, thereby a sealed state is formed in the tank-body 11. Next, the ice ice-water circulation unit 40 inputs the ice water into the tank-body 11 of the sealed microwave box 10 to form a low-temperature state in the tank body 11 (as shown in FIG. 2); and the microwave generators 14 generate microwave to rise temperature, and the generated microwave can penetrate the waterproof wave-transmittable plate 13 to heat the object to be extracted in the vacuum extraction tank 30; at the same time, the rotation of the magnetic plate 22 is driven by the rotary motor 21 of the stirrer 20 to synchronously drive the stirring plate 31 of the vacuum extraction tank 30 to rotate; so that the object to be extracted in the vacuum extraction tank 30 is uniformly disturbed and rotated in a circular motion; when the object to be extracted in the tank-body 11 is close to the microwave generators 14, the temperature is raised; and when it is rotated away, it can be cooled by the temperature conduction of the ice water. The object to be extracted is continuously stirred by the stirring plate 31, and the object to be extracted is rotated to repeatedly raise and lower the temperature, thereby allowing the cells of the object to be subjected to cooling and heating interaction; and its cell wall will be broken by repeated thermal expansion and contraction; at this time, the effective ingredients and the active substances in the cells of the object to be extracted can be separated and flowed out to achieve the purpose of extraction.

After the extraction operation is completed, the ice-water circulation unit 40 is turned off, and the temperature of the object to be extracted in the vacuum extraction tank 30 is adjusted and controlled to an appropriate temperature by the microwave control of the microwave generators 14; then, the vacuum machine 33 and the vacuum pump 34 are turned on to form a vacuum in the vacuum extraction tank 30; and the water liquid or solvent in the vacuum extraction tank 30 is evaporated to perform the function of concentration under reduced pressure.

Therefore, the present invention has the following advantages:
1. Since the present invention immerses the tank-body 11 in ice water, and then uses the microwave generators 14 to raise the temperature, the object to be extracted can be heated and cooled repeatedly; and the cells to be extracted are accelerated to expand and contract by heating and cooling to form an extract, thereby effectively improve the extraction speed and extraction efficiency.
2. Since the present invention uses the microwave generators 14 to generate microwave heating, it can adjust to increase the emission angle of the microwave generators 14, so as to increase the area of the microwave oscillation, thereby improving the extraction efficiency and productivity.
3. Since the present invention uses the microwave generated by the microwave generators 14 to penetrate the waterproof wave-transmittable plates 13 to raise the temperature and heat the object to be extracted in the tank-body 11, and it uses the ice water in the sealed microwave box 10 to lower the temperature of the object to be extracted; its components are simple and the composition is clear, so it can reduce the blockage and damage, thereby reducing the repair and maintenance costs.

I claim:

1. A microwave extraction system, which comprises a sealed microwave box, a stirrer, a vacuum extraction tank, a vacuum machine, and an ice-water circulation unit;
wherein the sealed microwave box is a tank-body for accommodating the vacuum extraction tank and the stirrer;
wherein at least two sets of notches are recessedly set on the side walls of the tank-body, and the side walls of the notches are set with waterproof wave-transmittable plates;
wherein at least two sets of notches are recessedly set on the side walls of the tank-body, and the side walls of the notches are set with waterproof wave-transmittable plates;
wherein the two sets of notches are set with microwave generators, which the microwave generated by the microwave generators can penetrate into the tank-body through the waterproof wave-transmittable plates;
wherein the notches are set with protective plates facing the outer sides of the microwave generators, and the protective plates can prevent and block the microwave generated by the microwave generators from leaking out;
wherein the tank-body is set with a sealing cap which is pivotally set with sealing drivers, and the sealing cap can be tightly covered on the tank-body and a sealed space is formed in the tank-body by the driving and controlling of the sealing drivers;
wherein the stirrer is set on the bottom side of the sealed microwave box and comprises a rotary motor pivotally connected with a magnetic plate, and the magnetic plate can be rotated by the driving of the rotary motor;
wherein the vacuum extraction tank is set in the sealed microwave box for providing the object to be extracted to be placed in, and the vacuum extraction tank can also provide the microwave to penetrate;
wherein a stirring plate is set in the vacuum extraction tank, and the stirring plate corresponds to the magnetic plate of the stirrer; when the magnetic plate rotates, the stirring plate can rotate synchronously to stir the object to be extracted;
wherein the microwave generators are pivotally connected with a microwave protective device, and the microwave protective device is connected with a sensing piece;
wherein the sensing piece extends into the vacuum extraction tank for sensing the temperature in the vacuum extraction tank; thereby adjusting and controlling the microwave intensity of the microwave generators;
wherein the vacuum extraction tank is set with an extraction sealing cap for closing and sealing the vacuum extraction tank, which a vacuum machine and a vacuum pump are set on the sealing cap; therefore a vacuum state can be formed in the vacuum extraction tank to perform the function of concentration under reduced pressure;
wherein the ice-water circulation unit comprises an ice-water cycle machine pivotally connected with a pipeline;
wherein the pipeline is pivotally connected with a freezer controller for making the water liquid transported from the ice-water cycle machine to form ice water in the pipeline;
wherein other end of the pipeline is connected with the tank body of the sealed microwave box, so that the ice water can be transported into the tank-body;
wherein the pipeline is pivotally connected with a sensing piece extending into the tank-body for sensing the temperature in the tank-body to adjust and control the temperature of the water liquid transported into the tank-body.
